(19) United States
(12) Patent Application Publication
(10) Pub. No.: US 2016/0046496 A1
(43) Pub. Date: Feb. 18, 2016

(54) HYDROGEN CYANIDE PRODUCTION WITH CONTROLLED FEEDSTOCK COMPOSITION

(71) Applicant: INVISTA TECHNOLOGIES S.à r.l., St. Gallen (CH)

(72) Inventors: John C. CATON, Yoakum, TX (US); David W. RABENALDT, Port Lavaca, TX (US)

(73) Assignee: INVISTA NORTH AMERICA S.A R.L., Wilmington, DE (US)

(21) Appl. No.: 14/741,744

(22) PCT Filed: Dec. 12, 2013
(86) PCT No.: PCT/US13/74542

§ 371 Date: Jun. 17, 2015

Related U.S. Application Data
(60) Provisional application No. 61/738,638, filed on Dec. 18, 2012.

(51) Int. Cl. C01C 3/02

(52) U.S. Cl. CPC C01C 3/0212

(57) ABSTRACT

The present invention relates to a process for producing hydrogen cyanide and more particularly, to a process for economically producing hydrogen cyanide. More particularly, the present invention relates to the controlled use of a ternary gas mixture including a methane-containing gas comprising less than 1 vol. % C2+ hydrocarbons, such as, for example, less than 5,000 mpm C2+ hydrocarbons, an ammonia-containing gas, and an oxygen-containing gas for production of hydrogen cyanide at enhanced levels of productivity and yield.

### CROSS REFERENCE TO RELATED APPLICATION

This application claims priority to U.S. App. 61/738,638, filed Dec. 18, 2012, the entire contents and disclosures of which are incorporated herein.

### FIELD OF THE INVENTION

The present invention relates to a process for producing hydrogen cyanide. More particularly, the invention relates to a process for producing hydrogen cyanide at enhanced levels of productivity and yield by using a controlled feedstock composition including a methane-containing gas comprising less than 1 vol. % C2+ hydrocarbons.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. No. 1,934,838 and U.S. Pat. No. 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

### SUMMARY OF THE INVENTION

In one embodiment, the present invention is directed to a process for producing hydrogen cyanide comprising: mixing components of a ternary gas mixture in a mixing zone to form a ternary gas mixture comprising at least 25 vol. % oxygen, wherein the components of the ternary gas mixture include an oxygen-containing gas, an ammonia-containing gas, and a methane-containing gas comprising less than 1 vol. % C2+ hydrocarbons, e.g., less than 5000 mpm, less than 1000 mpm, less than 150 mpm or substantially free of C2+ hydrocarbons, and contacting the ternary gas mixture with a suitable catalyst in a reaction assembly to provide a reaction product containing hydrogen cyanide. The process further comprises determining the methane content of a natural gas source and purifying the natural gas source when the methane content is determined to be less than 90 vol. %. The ternary gas mixture may be non-detonable and may have a pressure from 200 to 400 kPa. The methane-containing gas may be formed from a natural gas source. The natural gas is purified to form the methane-containing gas by passing the natural gas through a hydrocarbon separator to form a methane-containing gas and a purge stream comprising C2+ hydrocarbons. Additionally, the natural gas may be purified by removing water to form a substantially anhydrous methane-containing gas. The molar ratio of ammonia-to-oxygen in the ternary mixture may be from 1.2 to 1.6, and a molar ratio of ammonia-to-methane in the ternary gas mixture may be from 1 to 1.5, e.g., from 1.10 to 1.45. The methane-containing gas may be substantially free of contaminants. In some embodiments, the methane-containing gas may be anhydrous, substantially free of components having two or more carbon atoms, and substantially free of contaminants. In some embodiments, the oxygen-containing gas may be substantially anhydrous. The oxygen-containing gas may comprise at least 21 vol. % oxygen, e.g., at least 28 vol. % oxygen, at least 80 vol. % oxygen, at least 95% oxygen or pure oxygen.

In a second embodiment, the present invention is directed to a process for producing hydrogen cyanide comprising providing components of a ternary gas mixture, wherein the components of the ternary gas mixture include a methane-containing gas comprising less than 5,000 mpm C2+ hydrocarbons, e.g., less than 1000 mpm or substantially free of C2+ hydrocarbons, an ammonia-containing gas, and an oxygen-containing gas; introducing the components of the ternary gas mixture into a mixing zone within a reaction assembly to form a ternary gas mixture comprising at least 25 vol. % oxygen; and contacting the ternary gas mixture with a catalyst in the reaction assembly to provide a reaction product comprising hydrogen cyanide. The process further comprises determining methane content of the methane-containing gas and purifying the methane-containing gas when the methane content is determined to be less than 90 vol. %. The methane-containing gas may include less than 1,000 mpm C2+ hydrocarbons or may be substantially free of C2+ hydrocarbons. The methane-containing gas may be substantially free of C3+ hydrocarbons and may be substantially free of contaminants.

In a third embodiment, the present invention is directed to a process for producing hydrogen cyanide comprising: mixing components of a ternary gas mixture in a mixing zone to form a ternary gas mixture comprising at least 25 vol. % oxygen, wherein the components of the ternary gas mixture include an oxygen-containing gas, an ammonia-containing gas, and a methane-containing gas comprising less than 1 vol. % C2+ hydrocarbons; and contacting the ternary gas mixture with a catalyst in a reaction assembly to provide a reaction product containing hydrogen cyanide. The process further comprises determining methane content of a natural gas stream and purifying the natural gas stream when the methane content is determined to be less than 90 vol. %. The purifying may be conducted using cryogenic expansion, to form the methane-containing gas and to form a purge stream comprising C2+ hydrocarbons.

### BRIEF DESCRIPTION OF THE DRAWING

FIG. 1 is a simplified schematic flow diagram of an HCN synthesis system according to an embodiment of the present invention.

FIG. 2 is a graphical representation of the effect of ethane in the methane-containing gas on conversion of ammonia to HCN.

FIG. 3 is a graphical representation of the effect of ethane in the methane-containing gas on ammonia recycle requirements for the production of HCN.

FIG. 4 is a graphical representation of the effect of ethane in the methane-containing gas on the methane concentration in the off-gas feed stream of a HCN synthesis reaction.

FIG. 5 is a graphical representation of the effect of ethane in the methane-containing gas on conversion of carbon to HCN.

### DETAILED DESCRIPTION OF THE INVENTION

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group of consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

In the Andrussow process for forming HCN, methane, ammonia and oxygen raw materials are reacted at temperatures above about 1000° C. in the presence of a catalyst to produce a crude hydrogen cyanide product comprising HCN, hydrogen, carbon monoxide, carbon dioxide, nitrogen, residual ammonia, residual methane, and water. These components, i.e., the raw materials, are provided to the reactor as a ternary gas mixture comprising an oxygen-containing gas, an ammonia-containing gas and a methane-containing gas. The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. Natural gas is typically used as the source of methane while air, oxygen-enriched air, or pure oxygen can be used as the source of oxygen. As would be understood by one of ordinary skill in the art, the source of the methane may vary and may be obtained from renewable sources such as landfills, farms, biogas from fermentation, or from fossil fuels such as natural gas, oil accompanying gases, coal gas, and gas hydrates as further described in V N Parmon, “Source of Methane for Sustainable Development”, pages 273-284, and in Derouane, eds. Sustainable Strategies for the Upgrading of Natural Gas: Fundamentals, Challenges, and Opportunities (2003). For purposes of the present invention, the methane purity and the consistent composition of the methane-containing source is of significance.

The ternary gas mixture is passed over a catalyst to form a crude hydrogen cyanide product. The crude hydrogen cyanide product is then separated to recover HCN. In the present invention, the crude hydrogen cyanide product is also separated to recover hydrogen.

Natural gas, one source of the methane for the methane-containing gas, is an impure state of methane. That is, natural gas is a substantially methane-containing gas that can be used to provide the carbon element of the HCN produced in the process of the present invention. Natural gas may typically comprise from 60 to 99 vol. % methane, e.g., 70 to 90 vol. %. The remainder of the natural gas may be comprised of contaminants such as hydrogen sulfide (H₂S), carbon dioxide (CO₂), nitrogen (N₂), water (H₂O) and higher molecular weight hydrocarbons, such as ethane, propane, butane, pentane, and higher hydrocarbons, including isomers thereof. These higher molecular weight hydrocarbons are referred to herein as “C2+ hydrocarbons.” As the amount of impurities, on a volumetric percentage, increase, purification may be required. For example, if natural gas comprises above 90 vol. % methane, commercial processes may not purify the natural gas to remove the higher hydrocarbons. These prior commercial processes allowed larger quantities of C2+ hydrocarbons to enter the process, which causes adverse affects on productivity. Advantageously, the present invention reduces and controls the amount of C2+ hydrocarbons to improve productivity by decreasing unconverted ammonia and/or methane. Preventing unconverted ammonia and/or methane, i.e., “leaking through” the reactor has a significant impact on improving yields and conversions. In some aspects, the methane leakage through the reactor is from 0.05 to 1 vol. %, e.g., from 0.05 to 0.55 vol. % or from 0.2 to 0.3 vol. % The ammonia leakage through the reactor may range from 0.01 to 0.04 vol. %, e.g., from 0.05 to 0.3 vol. % or from 0.1 to 0.3 vol. %. Improving the conversion and overall yield of HCN, even by small amounts of 2% to 7%, may translate into a savings of millions of dollars per year in continuous commercial operation. Additionally, reducing the amount of methane leakage may reduce the buildup of nitriles during the separation of the crude hydrogen cyanide product. This reduction or elimination of a nitriles purge during the separation may also translate into an increased overall yield of HCN and capital savings.

Natural gas composition can vary significantly from source to source. The composition of natural gas provided by pipeline can also change significantly over time and even over short time spans as natural gas sources are taken on and off of the pipeline. Such variation in composition, especially with regard to the presence of and amount of C2+ hydrocarbons, leads to difficulty in sustaining optimum and stable process performance. The presence of C2+ hydrocarbons in the natural gas composition is especially troublesome due to 1) their higher heating value than methane, 2) their deactivating effect on the catalyst in the HCN reactor, especially C3+ hydrocarbons, and 3) side reactions that may form higher nitriles, e.g., acetonitrile, acrylonitrile and propionitrile.

In some embodiments, the process of the present invention may comprise determining methane content of the methane-containing source and purifying the methane-containing source when the methane content is determined to be less than 90 vol. %. Methane content may be determined using gas chromatograph-based measurements, including Raman Spectroscopy. The methane content may be determined continuously in real time or as needed when new sources of methane-containing sources are introduced into the process. In addition, to achieve higher purities, the methane-containing source may be purified when the methane content is above 90 vol. %, e.g., from 90 to 95 vol. %. Known purification methods may be used to purify the methane-containing source to remove oil, condensate, water, C2+ hydrocarbons (e.g., ethane, propane, butane, pentane, hexane, and isomers thereof), sulfur, and carbon dioxide.

Therefore, the present invention is directed to a process for producing hydrogen cyanide using a methane-containing gas comprising less than 1 vol. % C2+ hydrocarbons, e.g., less than 5000 mpm, less than 1000 mpm, less than 150 mpm or that is substantially free of C2+ hydrocarbons. “Substantially free of C2+ hydrocarbons” includes from 0 to 100 mpm C2+ hydrocarbons. This methane-containing gas may also be referred to herein as “purified natural gas.” In some embodiments, the methane-containing gas is substantially free of contaminants. Additionally, the methane-containing gas may be substantially anhydrous. Water may be removed from the methane-containing source prior to separation of C2+ hydrocarbons, using one or more molecular sieve columns.

The present invention is also directed to processes for reducing and/or removing the C2+ hydrocarbons from the natural gas to provide a methane-containing gas comprising less than 1 vol. % C2+ hydrocarbons, e.g., less than 5000 mpm, less than 1000 mpm, less than 150 mpm or that is substantially free of C2+ hydrocarbons. Additionally, the methane-containing gas may be treated to be substantially free of C3+ hydrocarbons. When present, C3+ hydrocarbons may contribute to coking on the catalyst.

Using purified natural gas to obtain the methane-containing gas, to produce HCN increases the catalyst life and yield of HCN. In particular, utilizing the purified natural gas stream stabilizes the remaining composition at a consistent level to allow downstream HCN synthesis to be optimized, and enable the use of highly enriched or pure oxygen feed streams by mitigating large temperature excursions in the HCN synthesis step that are typically related to variation in higher hydrocarbon content and which are detrimental to optimum yield and operability, such as catalyst damage, interlock, and loss of uptime. Using the purified natural gas also minimizes formation of higher nitriles and minimizes the associated yield losses of HCN during removal of nitriles. In addition, use of the purified natural gas as the source of the methane-containing gas minimizes variability in the feed stock by stabilizing the carbon and hydrogen content as well as the fuel values and thereby stabilizes the entire HCN synthesis system allowing for the determination and control of optimum methane-to-oxygen and ammonia-to-oxygen molar ratios for stable operation and more efficient HCN yield. Further, using the purified natural gas minimizes related temperature spikes and resulting catalyst damage.

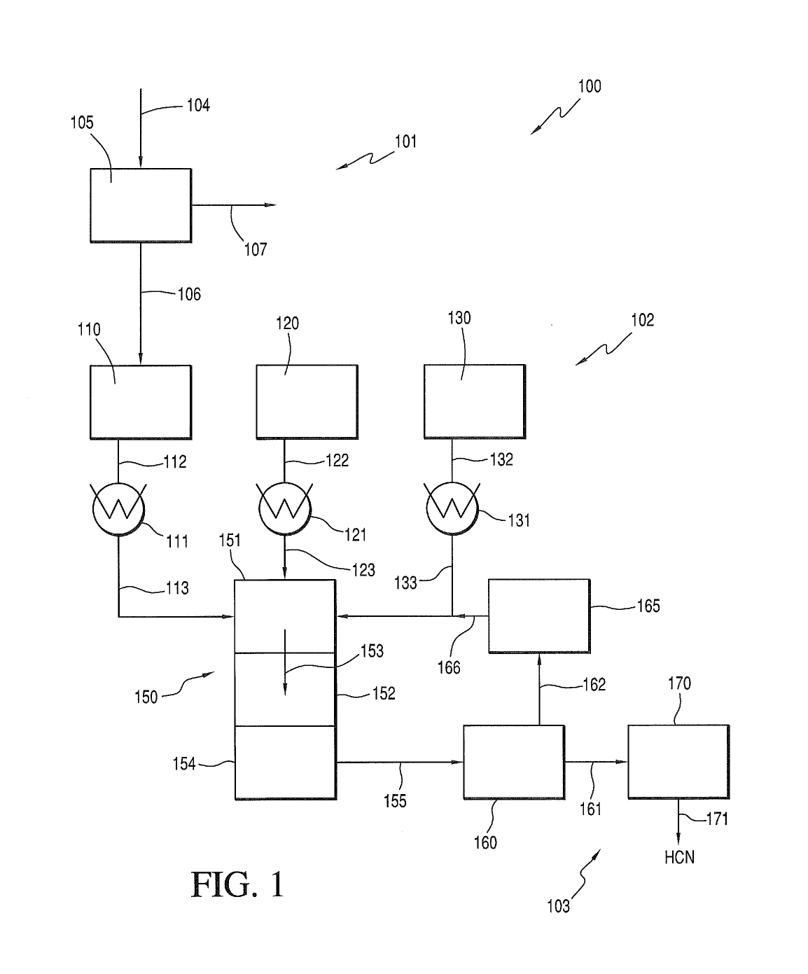

Generally, and referring now to FIG. 1, shown therein is a process for producing hydrogen cyanide, also referred to as an HCN synthesis system 100. Generally, the HCN is produced in a reaction assembly 150 which includes a mixing vessel 151 and a reactor 152. A methane-containing gas 112 from methane source 110, an oxygen-containing gas 122 from oxygen source 120 and an ammonia-containing gas 132 from ammonia source 130 (sometimes referred to herein as gases 112, 122 and 132) are introduced from gas zone 102 into the mixing vessel 151. Each gas 112, 122 and 132 may be independently preheated in preheaters 111, 121, and 131, respectively, to form pre-heated gases 113, 123 and 133, respectively, and then fed to mixing vessel 151. In some embodiments, the ammonia-containing gas and the methane-containing gas may be combined prior to being fed to mixing vessel 151 (not shown). A ternary gas mixture 153 is formed. This ternary gas mixture is flammable, but non-detonable. The ternary gas mixture 153 has a pressure from 200 to 400 kPa, e.g., from 230 to 380 kPa. Unless otherwise indicated as gauge, all pressures are absolute. The ternary gas mixture 153 is contacted with a catalyst contained in reactor 152 to form a crude hydrogen cyanide product that is cooled in heat exchanger 154 and which then exits the reaction assembly via line 155 to enter HCN purification zone 103. Ammonia can be recovered from the crude hydrogen cyanide product 155 by separating the crude hydrogen cyanide product 155 into an ammonia stream 162 and a hydrogen cyanide product stream 161 in an ammonia recovery section 160. Ammonia stream 162 may be further processed in ammonia processing zone 165 and the hydrogen cyanide product stream 161 can be further refined in an HCN refining section 170 to a purity required for the desired use. The processed ammonia stream may be combined via line 166 with ammonia-containing gas 132 or preheated ammonia-containing gas 133. Thus, processed ammonia stream 166 may be recycled to the reactor. High purity HCN 171 may contain less than 100 mpm by weight water. One possible use for a high purity HCN is hydrocyanation, such as hydrocyanation of an olefin-containing group. Another possible use for a high purity HCN is in the manufacture of adiponitrile (“ADN”) by hydrocyanation of 1,3-butadiene and pentenenitrile to adiponitrile.

FIG. 1 further shows a purification process 101 for methane source 110. Natural gas is fed via line 104 to hydrocarbon separator 105 to form a purge stream 107 comprising C2+ hydrocarbons and a purified natural gas stream 106. Hydrocarbon separator 105 may use an absorption process or a cryogenic expansion process to separate C2+ hydrocarbons from the purified natural gas stream. Purified natural gas stream 106 is used as methane source 110. If the absorption process is used, hydrocarbon separator 105 comprises absorption towers containing absorption oil. This absorption oil has an affinity for C2+ hydrocarbons. Once removed from the absorption tower, the C2+ hydrocarbons may be recovered from the absorption oil and used in other processes. If the cryogenic process is used, hydrocarbon separator 105 may comprise a cryogenic expansion turbine to cool the natural gas stream to a temperature of approximately minus 49° C., and a cryogenic distillation column. Operating at this temperature, the C2+ hydrocarbons are condensed while methane remains in the gas phase. The cryogenic expansion process may be preferred to reduce the ethane content in the natural gas. The absorption process may be preferred to reduce C3+ hydrocarbon content in the natural gas. Thus, the type of hydrocarbon separation process may be chosen depending on the natural gas composition. Existing hydrocarbon separation processes are described in U.S. Pat. Nos. 4,022,597; 4,687,499; 4,698,081 and 5,960,644, the entire contents and disclosures of which are incorporated by reference herein.

Regardless of whether the absorption method or the cryogenic expansion process is used, the hydrocarbon separator may further comprise a deethanizer, a depropanizer, and a debutanizer to separate ethane, propane and butane from methane. The hydrocarbon separator may further comprise a deisobutanizer to remove isobutane.

### Additional Natural Gas Purification

The natural gas may additionally be treated to remove other contaminants and to remove water.

In some embodiments, the natural gas 104 is first fed to an amine system (not shown). The amine system can be provided with an amine contactor for contacting the natural gas stream with a combined lean amine stream formed from combining a first lean amine stream (make-up) with a recycled second lean amine stream. The combined lean amine stream contains about 50 vol. % methyldiethanolamine (MDEA) and reacts with carbon dioxide and sulfides, if present, in the natural gas to provide the second natural gas substantially depleted of carbon dioxide, hydrogen sulfide, and other sulfur compounds, and a rich amine stream enriched with carbon dioxide, hydrogen sulfide and other sulfur compounds removed from the natural gas stream 104. The rich amine stream can be fed to an amine separator wherein the carbon dioxide, hydrogen sulfide, and other sulfur compounds are separated from the rich amine stream to thereby create the second lean amine stream and a carbon dioxide-to-hydrogen sulfide amine separator top stream. The carbon dioxide-to-hydrogen sulfide amine separator top stream can be routed to a flare stack where any trace hydrocarbons and hydrogen sulfide are burned.

Optionally, the treated and purified natural gas stream may be further treated downstream. In another embodiment, the natural gas 104 may be subjected to a zinc oxide treatment system (not shown) prior to being fed to the amine contactor. Prior to being fed to the zinc oxide treatment system (not shown), the natural gas 104 can be heated to at least 100° C. and the heated natural gas stream can be contacted with a zinc oxide catalyst. The amount of zinc oxide catalyst used is dependent upon the flow of the natural gas 104. However in one embodiment, the zinc oxide catalyst is supported on a sloped screen and has a catalyst density of 65 pounds per cubic foot. In another alternate embodiment, the zinc oxide treatment system (not shown) can be designed to remove hydrogen sulfide from natural gas with less than 0.2 mpm H₂S leakage. If the natural gas 104 is heated to 100° C., it is calculated that the zinc oxide catalyst can absorb approximately 5% by weight of sulfur prior to exhaustion. In the event that the natural gas 104 contains organic sulfur, the zinc oxide treatment system (not shown) may also include an activated carbon system (also not shown).

The rich amine stream contains carbon dioxide, hydrogen sulfide, and other sulfur compounds removed from the natural gas 104 in the amine contactor. The rich amine stream is withdrawn from the bottom of the amine contactor and fed into the amine separator where the carbon dioxide, hydrogen sulfide, and other sulfur compounds are stripped from the rich amine stream to provide the second lean amine stream. The carbon dioxide, hydrogen sulfide, and other sulfur compounds removed from the rich amine stream in the amine separator are taken off the top of the amine separator and can be sent, via an amine separator top stream, to a flare stack where the hydrogen sulfide is burned. The second lean amine stream is then recycled and combined with the first lean amine stream so that the combined lean amine stream can be fed into the amine contactor.

In another embodiment, the amine system includes filters, such as sock filters to remove particulate solids, and activated carbon filters to remove organics from the rich amine stream which can cause foaming in the amine contactor after the rich amine stream is processed in the amine separator and recycled to the amine contactor as the resulting second lean amine stream. The filters can include an activated carbon bed to facilitate removal of the particulate solids and organics found in the rich amine stream, in the amine contactor, and/or in the amine separator.

In another alternative embodiment, a stream containing antifoaming agent is introduced into the combined lean amine stream prior to introduction of the combined lean amine stream into the amine contactor. The antifoaming agent retards foaming in the amine contactor. A wide range of antifoaming agents can be used such as, for example, polyglycol. The amounts of antifoaming agent or agents vary with the particular antifoaming agent used and with the operating conditions of the particular process employed. It is understood that the antifoaming agents may also be added to any other stream wherein foaming may occur, such as in a carbon dioxide separation system, described herein.

The second natural gas stream, substantially depleted of carbon dioxide, hydrogen sulfide, and other sulfur compounds, is taken off the top of the amine contactor and fed to the dehydration system. The dehydration system can include one or more molecular sieve columns for removing water from the second natural gas to prevent ice formation in the hydrocarbon separator 105. A filter, such as a dust filter, removes from the second natural gas any particulate matter, such as dust from the molecular sieve column, to produce a third natural gas.

### Enhanced Oxygen Content

As described herein, the C2+ hydrocarbon content of the methane-containing gas 112 becomes increasingly important as the oxygen content of the oxygen-containing gas 122 increases, or is enhanced.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. In some embodiments, oxygen-enriched air comprises at least 28 vol. % oxygen, e.g., at least 80 vol. % oxygen, at least 95 vol. % oxygen, or at least 99 vol. % oxygen.

The formation of HCN in the Andrussow process is often represented by the following generalized reaction:

2CH₄+2NH₃+3O₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

Three basic side reactions also occur during the synthesis of HCN:

CH₄+H₂O→CO+3H₂

2CH₄+3O₂→2CO+4H₂O

4NH₃+3O₂→2N₂+6H₂O

In addition to the amount of nitrogen generated in the side reactions, additional nitrogen may be present in the crude product, depending on the source of oxygen. Although the prior art has suggested that oxygen-enriched air or pure oxygen can be used as the source of oxygen, the advantages of using oxygen-enriched air or pure oxygen have not been fully explored. When using air as the source of oxygen, the crude hydrogen cyanide product comprises the components of air, e.g., approximately 78 vol. % nitrogen, and the nitrogen produced in the ammonia and oxygen side reaction.

Due to the large amount of nitrogen in air, it is advantageous to use oxygen-enriched air (which contains less nitrogen than air), in the synthesis of HCN because the use of air as the source of oxygen in the production of HCN results in the synthesis being performed in the presence of a larger volume of inert gas (nitrogen) necessitating the use of larger equipment in the synthesis step and resulting in a lower concentration of HCN in the product gas. Additionally, because of the presence of the inert nitrogen, more methane is required to be combusted (when air is used, as compared to oxygen-enriched air) in order to raise the temperature of the ternary gas mixture components to a temperature at which HCN synthesis can be sustained. The crude hydrogen cyanide product contains the HCN and also by-product hydrogen, methane combustion byproducts (carbon monoxide, carbon dioxide, water), residual methane, and residual ammonia. However, when using air (i.e., approximately 21 vol. % oxygen), after separation of the HCN and recoverable ammonia from the other gaseous components, the presence of the inert nitrogen renders the residual gaseous stream with a fuel value that may be lower than desirable for energy recovery.

Therefore, the use of oxygen-enriched air or pure oxygen instead of air in the production of HCN may provide several benefits, including an increase in the conversion of natural gas to HCN and a concomitant reduction in the size of process equipment. Thus, the use of oxygen-enriched air or pure oxygen reduces the size of the reactor and at least one component of the downstream gas handling equipment through the reduction of inert compounds entering the synthesis process. The use of oxygen-enriched air or pure oxygen also reduces the energy consumption required to heat the oxygen-containing feed gas to reaction temperature.

It has been found that both productivity and production efficiency of HCN can be significantly improved, while maintaining stable operation, in part, by providing an oxygen-containing gas sufficiently enriched in oxygen and by adjusting the molar ratio of ammonia-to-methane to a sufficiently high level. In one embodiment, the ternary gas mixture contains at least 25 vol. % oxygen the molar ratio of ammonia-to-oxygen in the ternary gas mixture is in the range from 1.2 to 1.6, e.g., from 1.3 to 1.5, the molar ratio of ammonia-to-methane in the ternary gas mixture is in the range from 1 to 1.5, e.g., from 1.10 to 1.45, and the molar ratio of methane-to-oxygen is in the range from 1 to 1.25, e.g., from 1.05 to 1.15. In another embodiment, the oxygen-containing gas contains at least 80 vol. % oxygen, the molar ratio of ammonia-to-oxygen in the ternary gas mixture is in a range from 1.2 to 1.6, and the molar ratio of ammonia-to-methane in the ternary gas mixture is in the range from 1.15 to 1.40. In some embodiments, the ternary gas mixture comprises at least 25 vol. % oxygen, e.g., at least 28 vol. % oxygen. In some embodiments, the ternary gas mixture comprises from 25 to 32 vol. % oxygen, e.g., from 26 to 30 vol. % oxygen.

### Ammonia-Containing Gas Preparation

Prior to being mixed with the oxygen-containing gas 122 and the methane-containing gas 112, the ammonia-containing gas source 130 may be subject to treatment. This processing may include removing contaminants, such as water, oil, and iron (Fe), from the ammonia-containing gas source 130. Contaminants in the ammonia-containing gas 132 can reduce catalyst life which results in poor reaction yields. The processing may include using processing equipment, such as vaporizers, and filters, to provide a treated ammonia-containing gas 132.

For example, commercially available liquid ammonia can be processed in a vaporizer to provide a partially purified ammonia vapor stream and a first liquid stream containing water, iron, iron particulate and other nonvolatile impurities. An ammonia separator, such as an ammonia demister, can be used to separate the impurities and any liquid present in the partially purified ammonia vapor stream to produce the treated ammonia-containing gas 132 (a substantially pure ammonia vapor stream) and a second liquid stream containing entrained impurities and any liquid ammonia present in the partially purified ammonia vapor stream.

In one embodiment, the first liquid stream containing water, iron, iron particulate and other nonvolatile impurities is fed to a second vaporizer where a portion of the liquid stream is vaporized to create a second partially purified ammonia vapor stream and a second, more concentrated, liquid stream containing water, iron, iron particulate and other nonvolatile impurities which can be further treated as a purge or waste stream. The second partially purified ammonia vapor stream can be fed to the ammonia separator. In another embodiment, the second, more concentrated, liquid stream containing water, iron, iron particulate and other nonvolatile impurities is fed to a third vaporizer to further reduce the ammonia content before treating as a purge or waste stream.

Foaming in the vaporizers can limit the vaporization rate of ammonia and decrease the purity of the ammonia vapor produced. Foaming is generally retarded by the introduction of an antifoaming agent into the vaporizers directly or into the vaporizer feed streams. The antifoaming agents belong to a broad class of polymeric materials and solutions that are capable of eliminating or significantly reducing the ability of a liquid and/or liquid and gas mixture to foam. Antifoaming agents inhibit the formation of bubbles in an agitated liquid by reducing the surface tension of the solutions. Examples of antifoaming agents include silicones, organic phosphates, and alcohols. In one embodiment, a sufficient amount of antifoaming agent is added to the ammonia-containing gas 132 to maintain an antifoaming agent concentration from about 2 to about 20 mpm in the ammonia-containing gas 132. A non-limiting example of an antifoaming agent is Unichem 7923 manufactured by Unichem of Hobbs, N. Mex. The processing of the ammonia-containing gas source 130 may also include a filter system for removing micro particulates in order to prevent poisoning of the catalyst in the reactor 152. The filter system can be a single filter or a plurality of filters.

All publications cited herein are incorporated in their entirety by reference into this specification.

As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

In order to demonstrate the present process, the following examples are given. It is to be understood that the examples are for illustrative purposes only and not to be construed as limiting the scope of the invention.

### Example 1

Natural gas is obtained from a pipeline and the contents of the natural gas are measured. The natural gas is fed to a hydrocarbon separator to form a purified natural gas. The hydrocarbon separator comprises a cryogenic expansion turbine to remove C2+ hydrocarbons. The hydrocarbon separator further comprises a deethanizer, a depropanizer, a debutanizer, and a deisobutanizer to remove C2+ hydrocarbons from the natural gas. The contents of the natural gas and the purified natural gas are shown in Table 1.

TABLE 1
COMPARISON OF NATURAL GAS AND PURIFIED NATURAL GAS

| Nominal Composition, vol. % | Natural Gas | Purified Natural Gas |
|---|---|---|
| Nitrogen | 0.01 to 0.5 | <1 |
| Carbon Dioxide | 2 to 10 | <300 mpm |
| Methane | 70 to 90 | at least 99 |
| Ethane | 2 to 15 | <1500 mpm |
| Propane | 2 to 10 | — |
| Butanes | 2 to 7 | — |
| Pentanes and Heavier | 0.1 to 3 | — |

### Example 2

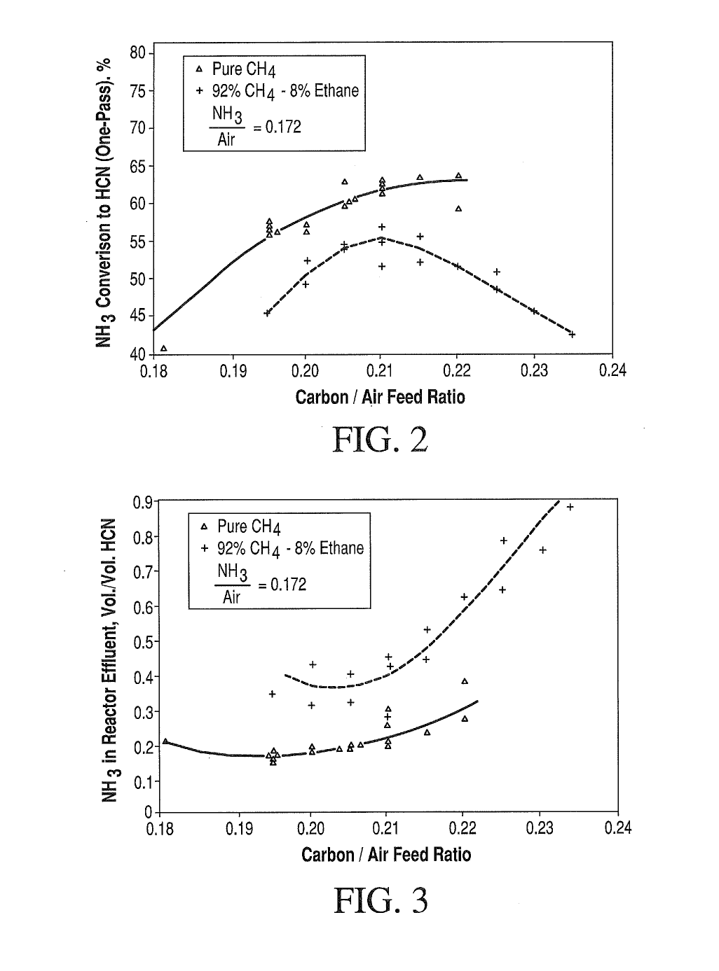

The utilization rates of ammonia in the HCN synthesis system are measured when differing compositions of methane-containing gases are used. Generally, ammonia conversion to HCN utilizing a one-pass synthesis process (i.e., no ammonia was recycled from downstream recycling and/or refining processes) decreases by 5-10% when the methane-containing gas contains approximately 8 vol. % ethane as compared to purified natural gas, referred to as substantially pure methane, as is shown in FIG. 2. The results of the above described experiment are demonstrated in FIG. 2 wherein the ammonia conversion to HCN is plotted against the carbon/air feed ratios for both a substantially pure methane-containing gas stream and a methane-containing gas stream containing 92 vol. % methane/8 vol. % ethane mixture. Similar trends are expected when using pure oxygen.

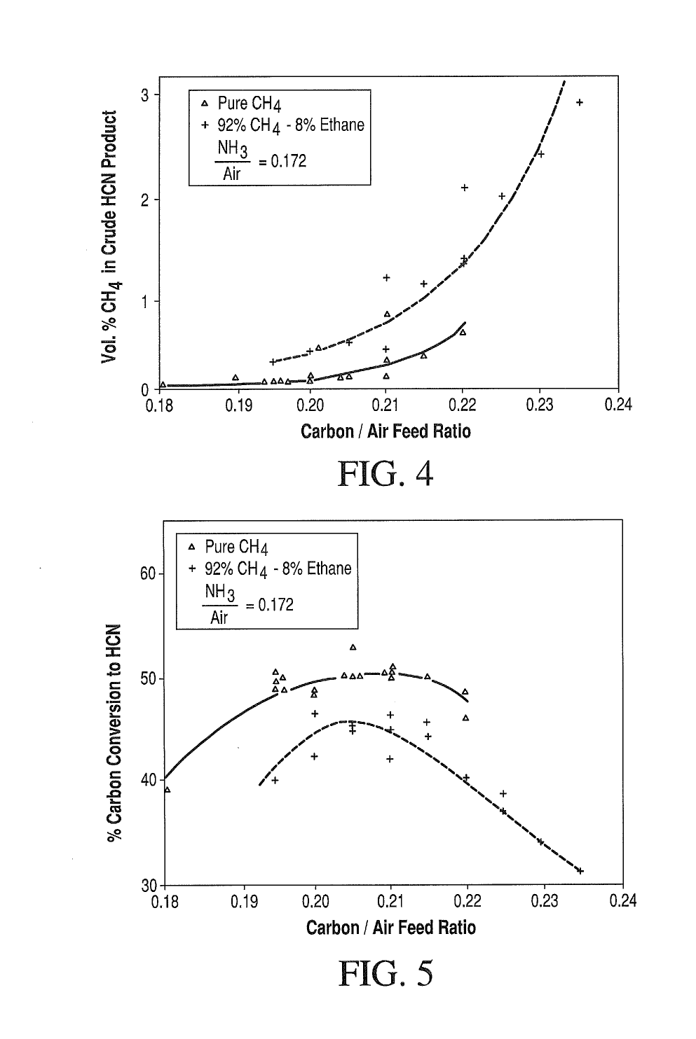

The results shown in FIG. 3 demonstrate a two fold increase in ammonia recycle requirements for any given carbon/air feed ratio when the methane-containing gas contains about 8 vol. % ethane. Since the ammonia conversion decreases at a constant ammonia yield, the ammonia leakage, i.e., the amount of ammonia that is not used/converted during the reaction increases. The presence of ethane in the methane-containing gas also causes a three-fold increase in methane leakage, i.e., the amount of methane that is not used/converted during the reaction as shown in FIG. 4. Similar trends are expected when using pure oxygen.

Finally, FIG. 5 shows that HCN yield from carbon in the methane-containing gas is 50% using a substantially pure methane-containing gas versus only a maximum of 45% HCN yield using a methane-containing gas containing 8 vol. % ethane and 92 vol. % methane. Thus, the presence of C2+ hydrocarbons in the methane-containing gas provided to the reactor causes (1) a drop in conversion of carbon to HCN; (2) an increase in the amount of ammonia unconverted or “leaking through” the reactor; (3) an increase in the amount of methane unconverted in the reactor; and (4) increased amounts of recycled ammonia required.

1-15. (canceled)

16. A process for producing hydrogen cyanide comprising:
(a) determining methane content of a methane-containing source;
(b) mixing components of a ternary gas mixture in a mixing zone to form a ternary gas mixture comprising at least 25 vol. % oxygen, wherein the components of the ternary gas mixture include an oxygen-containing gas, an ammonia-containing gas, and a methane-containing gas comprising less than 1 vol. % C2+ hydrocarbons; and
(c) contacting the ternary gas mixture with a catalyst in a reaction assembly to provide a reaction product containing hydrogen cyanide;
wherein the methane-containing gas is formed by purifying the methane-containing source, the purifying comprising passing the methane-containing source through a hydrocarbon separator to form the methane-containing gas and to form a purge stream comprising C2+ hydrocarbons.

17. The process of claim 16, wherein the ternary gas mixture is non-detonable.

18. The process of claim 16, wherein the ternary gas mixture has a pressure from 200 to 400 kPa.

19. The process of claim 16, wherein the methane-containing source is purified to be substantially anhydrous.

20. The process of claim 16, wherein a molar ratio of ammonia-to-oxygen in the ternary mixture is from 1.2 to 1.6, and a molar ratio of ammonia-to-methane in the ternary gas mixture is from 1 to 1.5.

21. The process of claim 16, wherein the methane-containing gas comprises less than 5,000 mpm C2+ hydrocarbons.

22. The process of claim 16, wherein the methane-containing gas is substantially free of C2+ hydrocarbons.

23. The process of claim 16, wherein the methane-containing gas is substantially free of C3+ hydrocarbons.

24. The process of claim 16, wherein the methane-containing gas is substantially free of contaminants.

25. The process of claim 16, wherein the oxygen-containing gas is substantially anhydrous.

26. The process of claim 16, wherein the oxygen-containing gas comprises greater than 80 vol. % oxygen.

27. The process of claim 16, wherein the oxygen-containing gas is pure oxygen.

28. The process of claim 16, wherein the hydrocarbon separator comprises absorption towers.

29. The process of claim 16, wherein the hydrocarbon separator comprises an expansion turbine.

30. The process of claim 16, wherein the hydrocarbon separator comprises a deethanizer, a depropanizer, a debutanizer, and/or a deisobutanizer.

31. A process for producing hydrogen cyanide comprising:
(a) determining methane content of a natural gas source;
(b) providing components of a ternary gas mixture, wherein the components of the ternary gas mixture include a methane-containing gas comprising less than 5,000 mpm C2+ hydrocarbons, an ammonia-containing gas, and an oxygen-containing gas;
(c) introducing the components of the ternary gas mixture into a mixing zone within a reaction assembly to form a ternary gas mixture comprising at least 25 vol. % oxygen; and
(d) contacting the ternary gas mixture with a catalyst in the reaction assembly to provide a reaction product comprising hydrogen cyanide;
wherein the methane-containing gas is formed by purifying the natural gas source.

32. The process of claim 31, wherein the methane-containing gas is substantially free of C2+ hydrocarbons.

33. The process of claim 31, wherein the methane-containing gas is substantially free of C3+ hydrocarbons.

34. The process of claim 31, wherein the methane-containing gas is substantially free of contaminants.

35. A process for producing hydrogen cyanide comprising:
(a) determining methane content of a methane-containing source;
(b) mixing components of a ternary gas mixture in a mixing zone to form a ternary gas mixture comprising at least 25 vol. % oxygen, wherein the components of the ternary gas mixture include an oxygen-containing gas, an ammonia-containing gas, and a methane-containing gas comprising less than 1 vol. % C2+ hydrocarbons; and
(c) contacting the ternary gas mixture with a catalyst in a reaction assembly to provide a reaction product containing hydrogen cyanide;
wherein the methane-containing gas is formed by purifying the methane-containing source by cryogenic expansion, to form the methane-containing gas and to form a purge stream comprising C2+ hydrocarbons.
